(19) United States
(12) Patent Application Publication
(10) Pub. No.: US 2003/0087004 A1
(43) Pub. Date: May 8, 2003

(54) Sweet and savory food bars for meal-equivalent nutrition segments

(76) Inventor: Emanuel S. Kemeny, Arlington, VA (US)

Correspondence Address: EMANUEL S. KEMENY, 1400 S. JOYCE ST. #602, ARLINGTON, VA, 22202, US

(21) Appl. No.: 10/326,103

(22) Filed: Dec. 23, 2002

Related U.S. Application Data
(63) Continuation-in-part of application No. 09/909,014, filed on Jul. 20, 2001.

(51) Int. Cl. A21D 13/00

(52) U.S. Cl. 426/76

(57) ABSTRACT

Sweet and savory (non-sweet) ready-to-eat food bars can provide improved nutrition and flavor by minimizing sugar and sugar-substitutes in a balanced-nutrition bar. Such improved bars are advantageously eaten singly or as segments of a meal-equivalent food bar assembly. Specifically, sugars (mono- and di-saccharides) and sugar-substitutes (sugar-related short-chain polymers) are powerful flavor sweeteners but should be used minimally—because they can stimulate unhealthy sugar-craving in athletes, diabetics, and overweights, and can overwhelm subtle flavors in sweet and savory bars. Unhealthy forms of fats are also minimized.

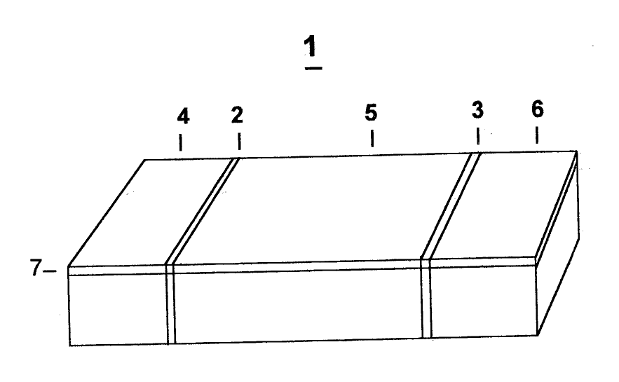

### RELATED APPLICATION DATA

This application is a continuation-in-part of U.S. Ser. No. 09/909,014, filed Jul. 20, 2001, co-pending.

### BACKGROUND OF THE INVENTION

The invention is in the field of ready-to-eat food bars, and more particularly, sweet and savory (non-sweet) food bars which can be eaten singly or as segments of a meal-equivalent food bar assembly.

“Common” food bars taste either sweet or savory—for example, sweet candy bars versus savory meat jerky bars. However, these bars do not provide a healthy balance of dietary nutrients.

“Dietary” food bars provide ingredients for normal or special diets, and may feature dietary proportions of carbohydrates, proteins, and fats, plus nutraceuticals, preservatives, and functional additives. Dietary examples include: Diabetic bars low in sugar, salt, and animal fat; Energy bars high in sugar; and Body-Building bars high in protein. However, these bars are usually unpleasantly sweet or unflavorful.

In particular, problems arise with the use of sugar (mono- or di-saccharides), and/or sugar-substitutes (sugar-related short-length polymers, eg: oligosaccharides and sweet alcohols). These are powerful flavor sweeteners—but can stimulate unhealthy sugar-craving in athletes, diabetics, and overweights; and can overwhelm subtle flavors, sweet or savory, in a bar. As a result, the use of such powerful flavor sweeteners can be detrimental when used in either sweet or savory flavored bars.

It is noted that sweet or savory bars can be eaten singly, or eaten in a meal-equivalent sequence, as we recall from the parent application incorporated herein by reference, where the inventive Meal-Equivalent Nutrition Bar has segments (flavored bars) which are equivalent to the courses of a Conventional Meal, usually:

Appetizer: savory, non-filling, almost any food; Main Course: savory, filling, meat, fish, fowl, vegetable; Dessert: sweet, non-filling, fruit, candy, pudding.

Such conventional meals are commonly detailed in culinary texts, see for example Fannie Farmer Cookbook, Knopf, N.Y., published regularly from 1890 to 1990, and incorporated herein by reference.

In view of the above background, the following prior art patents are cited as pertinent, revealing a variety of useful techniques and ingredients in making and using food bars. Comments are included to point out their relevence and divergence with respect to critical features of this invention:

[1] U.S. Pat. No. 2,634,210, Kimball, F. T., issued Apr. 7, 1953, teaches a rectangular chocolate bar with two layers to separate incompatable components, and with frangible transverse scored lines.

[2] U.S. Pat. No. 2,538,202, Kimball, F. T., issued Jan. 16, 1951, teaches a two-layer chocolate bar in cylindrical disc shape, in which a chocolate outer layer enrobes the core inner layer. The layers separate incompatible ingredients. Other essential ingredients are suggested if the food bar is to be the sole diet for a considerable time.

[3] U.S. Pat. No. 6,143,335, McKenzie, R. G., issued Nov. 7, 2000, teaches scoring a food bar into bite-sized pieces thus providing a method for delivering exact quantities of supplemental ingredients to animals or humans.

[4] U.S. Pat. No. 5,906,833, Klatz, R. M., issued May 25, 1999, teaches a dietary supplement food bar in plural parts which are chronologically appropriate for consumption.

[5] U.S. Pat. No. 4,820,533, Seaborne, et al, issued Apr. 11, 1989, teaches composition and manufacture of an edible barrier laminate to separate different food phases.

[6} U.S. Pat. No. 4,451,488, Cook, M. L., issued May 29, 1984, teaches composition and manufacture of a soft and chewy granola bar by adding polyhydric alcohols.

[7] U.S. Pat. No. 4,496,606, Michnowski, J., issued Jan. 29, 1985, teaches composition and manufacture of a dietetic snack-bar with high fiber guar gum for a Type II diabetic.

[8] U.S. Pat. No. 6,159,506, Bieser, A. H., issued Dec. 12, 2000, teaches folic acid in a food supplement to help quell stressful attacks on normal physiological and psychological functioning.

[9] U.S. Pat. No. 6,207,638, Portman, R., issued Mar. 27, 2001, teaches a nutritional composition which enhances appetite satiety for individuals who are: overweight, Type II diabetic, or bulemic.

[10] U.S. Pat. No. 2,168,360, Musher, A., issued Aug. 8, 1939, teaches a composition of solid food materials using fat as a carrier, with different types of products in block form in a single container.

[11] U.S. Pat. No. 1,174,826, Chapman, M. S., issued Mar. 7, 1916, teaches a pie of plural non-communicating sections which may contain different core ingredients, with separable portions conveniently eaten.

[12] U.S. Pat. No. 1,855,145, Jones, W. B., issued Apr. 19, 1932, teaches an edible cake or candy bar with alternating wedge sections of ingredients to vary the proportions as the bar is eaten, thus improving taste saturation and psychological pleasure effects of anticipation.

[13] U.S. Pat. No. 3,882,253, Schafer, et al, issued May 6, 1975, teaches a compacted and dehydrated food bar easily bitten and chewed, using 10% potato particles and 90% non-potato food bar forming ingredients.

[14] U.S. Pat. No. 4,543,262, Michnowski, J. E., issued Sep. 24, 1985, teaches a balanced nutrition snack bar using hydrogenated vegetable oil and sugar as the binder and shelf life with Water<10% and water activity a(w)<0.7.

[15] U.S. Pat. No. 5,776,887, Wibert et al, issued Jul. 7, 1998, teaches a diabetic nutritional product with glucose, cooked starch, and raw starch as three fractions of carbohydrate for controlled rate of absorbtion.

[16] Patent Application Publication No. US2002/0034574, Application No. 09/828,015, Prosise et al, published Mar. 21, 2002, teaches a balanced nutritional mix of carbohydrate, protein, and fat; sugars, glycerol and eggwhite; minimal digestible fat and maximal fiber.

All cited publications are hereby incorporated by reference.

COMMENT: The prior art discussed above reveals many useful techniques pertinent to the inventive bar, but is severely limited in features for avoiding: (1) taste boredom, (2) sugar-related problems, and (3) unhealthy forms of fat. These features are addressed in the inventive bar, which provides healthier ingredients for improved physiological support, and moderated flavors for improved psychological support for the consumer.

### SUMMARY OF THE INVENTION

This inventor has discovered that ready-to-eat food bars can provide improved nutrition and flavor—by minimizing sugar (mono- and di-saccharides) and sugar-substitutes (sugar-related short-chain polymers). Specifically, these ingredients are powerful flavor sweeteners—but can stimulate unhealthy sugar-craving in athletes, diabetics, and overweights, and can overwhelm subtle flavors in sweet or savory bars. Thus, the invention suggests: a minimal amount of sugar and sugar-substitutes (sugar/substitutes) in food bars; and a minimal amount of unhealthy fats.

Thus it is a first object of the invention to provide a healthier food bar, with balanced-nutrition, minimal stimulus of sugar-craving, and minimal forms of unhealthy fats.

It is a second object of the invention to provide a bar with delicate and/or intense flavors, for sweet or savory taste, and not overwhelmed by powerful sugar or sugar-substitute flavorants.

It is a third object of the invention to provide sweet and savory bars advantageously eaten alone or as segments of a meal-equivalent food bar assembly.

### BRIEF DESCRIPTION OF DRAWING

The single drawing shows a perspective view of three of the inventive bars as segments of a meal-equivalent food bar.

### DETAILED DESCRIPTION OF THE INVENTION

One embodiment of the invention is seen in the drawing, where a rectangular meal-equivalent bar assembly (1) is shown apportioned by transverse dividers (2) and (3) into segments which correspond to the courses of a conventional meal: appetizer (4), main-course (5), and dessert (6). A topping (7) may be added to each segment of the base bar—with an appropriate segment flavor.

Referring to the drawing, the transverse dividers (2) and (3) may be: scored lines marking the segments, or segment connectors of edible binder material, or segment barriers of edible or inedible material.

Not shown in the drawing are markings and/or colors on the bar to offer instructions, identify segment ingredients, and improve visual appeal.

Details of ingredients and manufacture for one embodiment are described in the example below.

### EXAMPLE

Base Bar: OAT-SOY-CANOLA

The inventive bar allows dietary ranges of carbohydrates, proteins and fats, but carbohydrate sugar and sugar-substitutes are limited to less than 10% wt (% of total bar weight}. Also, unhealthy forms of fats (eg: hydrogenated oils) are limited to less than 10% wt. Ingredients may include:

| | |
|---|---|
| CARBOHYDRATES: | |
| Oat Bran | 5-70% (% wt) |
| Sugar/Substitutes | <10% |
| PROTEIN: | |
| Soy Protein Isolate | 10-30% |
| FAT: | |
| Canola Oil | 10-30% |
| Hydrogenated oil | <10% |
| OTHER: | |
| Nutraceuticals | See Below |
| Additives | See Below |

The % wt (percent of total weight) to total 100%

NOTE 1: Oats as oatbran is preferred over oatmeal for its higher ratio of fiber (25%) to starch (75%). Forty grams of oatbran supplies: 25 g carbohydrate, 5 g protein, and 6 g fat. The carbohydrate fiber contains 3 g soluble, and 3 g insoluble. Three grams of soluble fiber daily may help reduce cholesterol and heart disease.

NOTE 2: Soy protein isolate supplies a healthy balance of essential amino acids.

NOTE 3: Canola oil supplies a healthy balance of fatty acids.

NOTE 4: Nutraceuticals, eg: vitamins and minerals, supplied as 25% Daily Value (DV), is recommended.

NOTE 5: Additives might include preservatives (per the U.S. Food Codebook 21 CFR); manufacturing aids (eg: mold release and extrusion agents); humectants; modified starches and gums; and flavorants.

NOTE 6: Shelf-life is improved if, eg; acidity pH<5; water activity a(w)<0.9; Moisture<10%.

Note 7: Shelf-life without preservatives is improved, for example, by heating at sterilyzing temperatures, and packaging using impervious films.

NOTE 8: Alternative or additional nutrients include: Grains, meats, fish, fowl, eggwhite, rice and beans, cheese and vegetables, corn and tapioca products. These nutrients may be incorporated macerated, dried, or as flavor extracts.

NOTE 9: Flavors and toppings are available in various forms powder, liquid, paste (topping); various intensities (subtle or intense), and gourmet tastes of sweet and savory. For example I found: chicken stock or veal stock when diluted will add a subtle flavor to a base bar, and will allow an intense-flavor topping to dominate the bite taste. Cardomom and cinnamon provided spicy-sweet flavors for dessert.

NOTE 10. Toppings of intense flavor include: tomato pesto (appetizer); chicken olive paste, or lamb and curry (main course); and cherry-applesauce (dessert).

A method for improving dietary support is suggested by these teachings: the meal-equivalent food bar can be the basis of a method for improving the dietary support of food bars by varying the ingredients within the dietary guidelines for a variety of meals during the day.

In conclusion, alternative embodiments of ingredients and format will be readily apparent to one of ordinary skill in the art in view of the teachings above, and fall within the scope and spirit of the claims.

I claim:

1. A flavored dietary food bar comprising a body and an optional topping or coating, said body comprising a nutritional balance of dietary ingredients including carbohydrate, protein, and fat; said carbohydrate ingredient comprising components of sugars and sugar-substitutes, wherein said components total less than 10% wt (% of total weight) of the bar body.

2. The flavored dietary bar of claim 1 wherein
(a) said components comprise less then 10% wt in a sweet-flavored bar, and
(b) said components comprise less than 5% wt of a savory-flavored bar.

3. The bar of claim 1 wherein said components comprise less than 5% wt in a sweet-flavored bar, and said components comprise less than 2% wt in a savory-flavored bar.

4. The flavored, dietary food bar of claim 1 further comprising:
(a) a subtle flavor in the bar body, and
(b) a complementary intense flavor in a topping.

5. The food bar of claim 1 wherein
(a) said base bar comprises, by % wt (% of total weight of bar):
(i) 5 to 70% wt carbohydrates;
(ii) 10 to 50% wt proteins,
(iii) 10 to 50% wt fats, and
(iv) 0 to 15% wt additives, such that
the total per cent quantities add to 100%.

6. The food bar of claim 1 further comprising less than 10% wt unhealthy forms of fat.

7. An assemblage of three of the flavored, dietary bars of claim 1, forming three segments of a meal-equivalent food bar assembly, the segments equivalent to the course flavors of a conventional meal, comprising:
(a) An appetizer segment with savory flavor;
(b) A main-course segment with savory flavor; and
(c) A dessert segment with sweet flavor.

8. The food bar of claim 7 wherein the segments are packaged in separate impermeable housings.

9. The food bar of claim 7 wherein the segments are packaged in one impermeable housing.

10. A method for improving dietary support comprising
(a) supplying meal-equivalent food bar segments as part of a daily dietary regimen, and
(b) varying the food bar segment ingredients to a dietary guide to provide healthy dietary variations in meals during the day.
